(19) United States
(12) Patent Application Publication
(10) Pub. No.: US 2017/0169792 A1
(43) Pub. Date: Jun. 15, 2017

(54) ELECTRONIC DEVICE AND METHOD FOR RELEASING CONTENT TO MULTIPLE TERMINALS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lei ZOU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,070

(22) Filed: Aug. 22, 2016

Related U.S. Application Data
(63) Continuation of application No. PCT/CN2016/089535, filed on Jul. 10, 2016.

(30) Foreign Application Priority Data
Dec. 14, 2015 (CN) 2015109230696

(51) Int. Cl. G09G 5/00; H04L 29/06

(52) U.S. Cl. CPC G09G 5/005; H04L 63/0428; H04W 88/02

(57) ABSTRACT

An electronic device and method for releasing content to multiple terminals are provided. The electronic device includes: at least one processor; and a memory; wherein the memory stores instructions that can be executed by the at least one processor, and execution of the instructions by the at least one processor, causes the at least one processor to: receive a page request from a client wherein the page request comprises a type of the client; and determine one or more page sections in the requested page according to the page request; determine a data source of the one or more page sections; determine a display style of the one or more page sections according to the type of the client; and encapsulate the determined display style and data source of all page sections in the request, and send the encapsulated display style and data source to the client.

### CROSS-REFERENCE TO RELATED APPLICATIONS

The present application is a continuation of PCT application No. PCT/CN2016/089535 filed on Jul. 10, 2016, and claims priority to Chinese Patent Application No. 201510923069.6, filed with the Chinese Patent Office on Dec. 14, 2015, both of which are incorporated herein by reference in its entireties.

### TECHNICAL FIELD

Embodiments of the present application relate to information technologies, and in particular, to an electronic device and method for releasing content to multiple terminals.

### BACKGROUND

With the development of information technologies, at present multiple different types of terminals have already appeared in people's daily life, for example, a personal computer (PC, Personal Computer), a mobile terminal, and a television (TV), and also these terminals all have a function to access a server to acquire corresponding page information. FIG. 1 is a schematic diagram of an existing manner for releasing content to multiple terminals. As shown in FIG. 1, due to a larger difference between a PC 110, a mobile terminal 120, and a TV 130 in a software and hardware structure, a PC releasing module 210, a mobile terminal releasing module 20, and a TV releasing module 230 are deployed in a server 200, to separately release corresponding page information for the PC 110, the mobile terminal 120, and the TV 130.

Currently, an operation and maintenance personnel needs to separately maintain these releasing modules, and there is more repeated working. For example, if the same data appeared in a page distributed to the PC 110, the mobile terminal 120, and the TV 130 changes, to implement display of the data on the above-described different terminals, the operation and maintenance personnel needs to separately maintain the above-described three releasing terminals, which is heavier workload. In addition, for the above-described content releasing manner for multiple terminals,once adjustment of a page content structure is involved, an upgrade cycle is long because page layouts of various terminals are hardcoded for the releasing modules of the various terminals in the server; if adjustment of the module is involved, a new released version is required, severely affecting normal content operation work.

### SUMMARY

The present disclosure provides an electronic device and method for releasing content to multiple terminals, where a page is divided into sections, and page data is structured, with a display style of the coordinated sections, and the page is output to various terminals, so that an operation and maintenance personnel only needs to maintain content in a section, and the section may be reused in multiple pages sent to multiple terminals, so as to reduce maintenance workload.

On the first aspect, an embodiment of the disclosure provides a method for releasing content to multiple terminals, where the method includes:receiving a page request from a client, where the page request includes a type of the client; determining one or more page sections in the requested page according to the page request; determining a data source of the one or more page sections; determining a display style of the one or more page sections according to the type of the client; and encapsulating the determined display style and data source of all page sections in the request, and sending the encapsulated display style and data source to the client.

On the second aspect, an embodiment of the disclosure further provides a non-volatile computer storage medium, which stores a computer executable instruction, where the computer executable instruction is used to execute any of the foregoing methods for releasing content to multiple terminals of the disclosure.

On the third aspect, an embodiment of the disclosure further provides an electronic device, including: at least one processor; and a memory, where the memory stores a program that can be executed by the at least one processor, and the instruction is executed by the at least one processor, so that the at least one processor can receive a page request from a client, where the page request includes a type of the client; and determine one or more page sections in the requested page according to the page request; determine a data source of the one or more page sections; determine a display style of the one or more page sections according to the type of the client; and encapsulate the determined display style and data source of all page sections in the request, and send the encapsulated display style and data source to the client.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a schematic diagram of an existing manner for releasing content to multiple terminals;

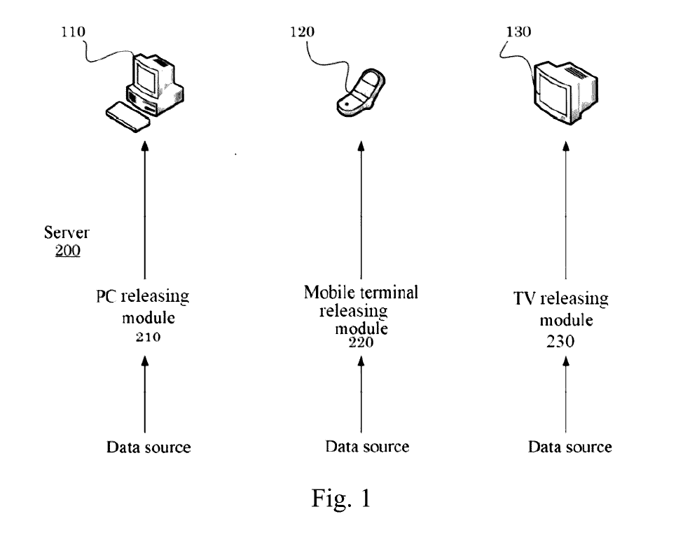

FIG. 2 is a schematic structural diagram of a system for releasing content to multiple terminals according to an embodiment of the present disclosure;

FIG. 3 is a schematic diagram of a page including multiple page sections;

FIG. 4 is a schematic diagram of a manner for releasing content to multiple terminals according to an embodiment of the present disclosure;

FIG. 5 is a flowchart of a method for releasing content to multiple terminals according to an embodiment of the present disclosure;and

FIG. 6 is a schematic structural diagram of hardware of a device for executing a method for releasing content to multiple terminals according to an embodiment of the present disclosure.

### DETAILED DESCRIPTION

To make the objectives, technical solutions, and advantages of the disclosure clearer, hereinafter, the technical solutions of the disclosure will be clearly and completely described by implementation manners with reference to the accompanying drawings in the embodiments of the disclosure. Apparently, the described embodiments are a part rather than all of the embodiments of the disclosure.

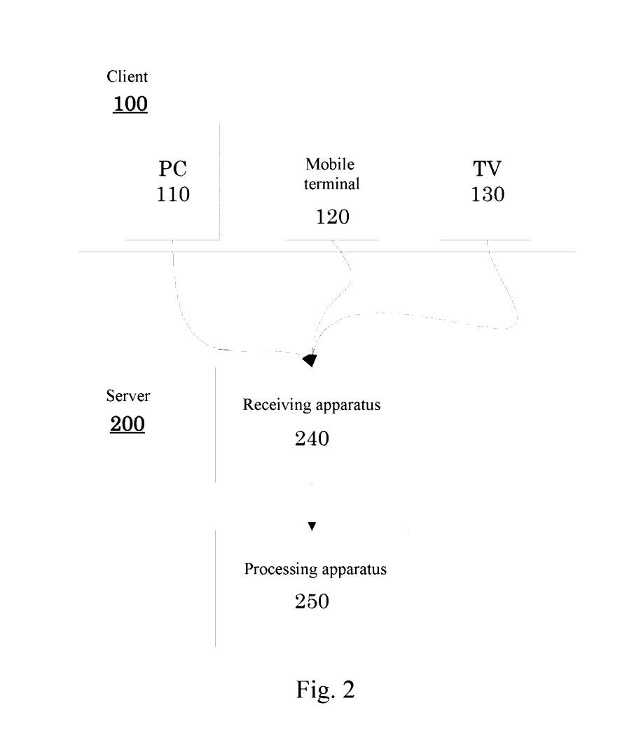

FIG. 2 is a schematic structural diagram of a system for releasing content to multiple terminals according to an embodiment of the present disclosure. As shown in FIG. 2, this embodiment provides a system for releasing content to multiple terminals, and the system includes: the foregoing device for releasing content to multiple terminals, where the device may be implemented in a server 200; and a client 100. The device for releasing content to multiple terminals includes: a receiving apparatus 240 configured to receive a page request from a client, where the page request includes a type of the client; and a processing apparatus 250 configured to execute the following operations: determining one or more page sections in the requested page according to the page request; determining a data source of the one or more page sections (for example, an image, a text, an animation, an audio, and a video, etc.); determining a display style of the one or more page sections (for example, a shape, a width, a height, and an image display effect (for example, horizontal scroll or vertical scroll) of the section) according to the type of the client; and encapsulating the determined display style and data source of all page sections in the request, and sending the encapsulated display style and data source to the client 100. The client 100 is configured to execute the following operations: sending the page request; receiving the encapsulated display style and data source in response to the page request; and rendering and displaying a page according to the encapsulated display style and data source. Thereby, each section is determined by data and the display style of the section, and the section may be reused in a page sent to different clients, so that a working personnel only needs to adjust one data source to be able to implement adjustment of data in the page sent to different terminals, and no longer needs to separately adjust a data source in a releasing module of each terminal.

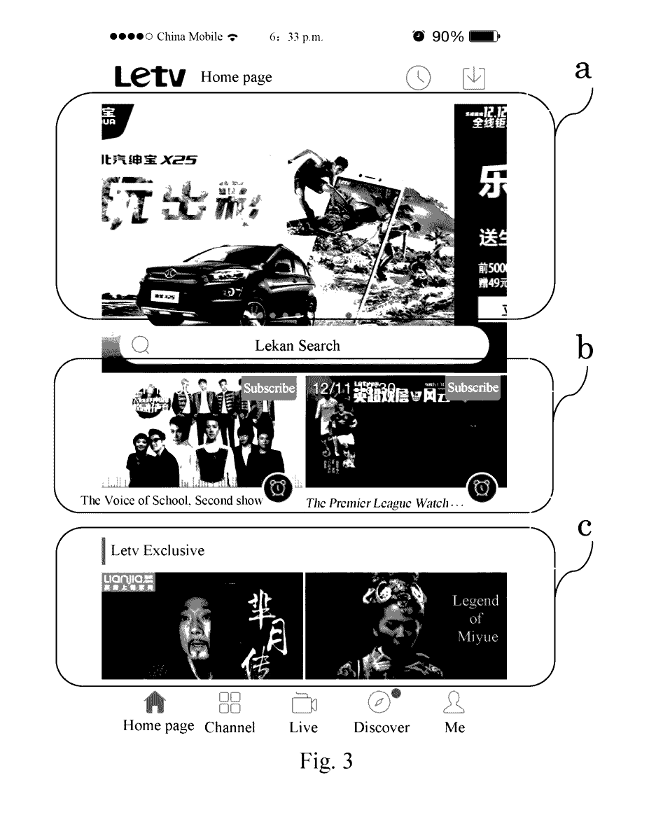

The requested page may be shown in FIG. 3, and includes three page sections a, b, and c, which are separately used to display an advertisement, a recommended video and a LeTV exclusive video.

The type of the client may include one or more of the following: a mobile phone, a computer, and a television. Certainly, the present disclosure is not limited herein, other electronic devices that may receive and display a page are also applicable here. The display style may consider these different types of clients, for example, for a television, duing to its generally larger display screen, a section in a page sent thereto may use one of larger width and height, to ensure a display effect; and for a mobile phone, duing to its smaller screen size a section in a page sent thereto may use one of smaller width and height, to make it convenient for a user to operate. Certainly, different section display styles may also be set according to different operating systems (for example, iOS, Android, and Windows, etc.) of the client.

The encapsulating the determined display style and data source of all page sections in the request comprises encapsulating the determined display style and data source of all page sections in the request in a JSON format, where the JSON format is a lightweight data-interchange format. In any case various types of terminals, inter alia, a mobile phone, a computer, and a television, may parse the JSON format file, to extract the display style and the data source therefrom, and thus to render and display the page according to the display style and the data source.

A mapping correspondence table between a page, a section, a data source of a section, a display style of a section, and a type of a client can be prestored in the device for releasing content to multiple terminals, and after receiving a page request from aclient, the device may encapsulate the section and sends to the client according to the page, the type of the client, the data source of the section in the page, and the display style of the section. Therefore, a working personnel may maintain a page by maintaining the correspondence table, and may change a data source and/or a display style of a section by amending the correspondence table.

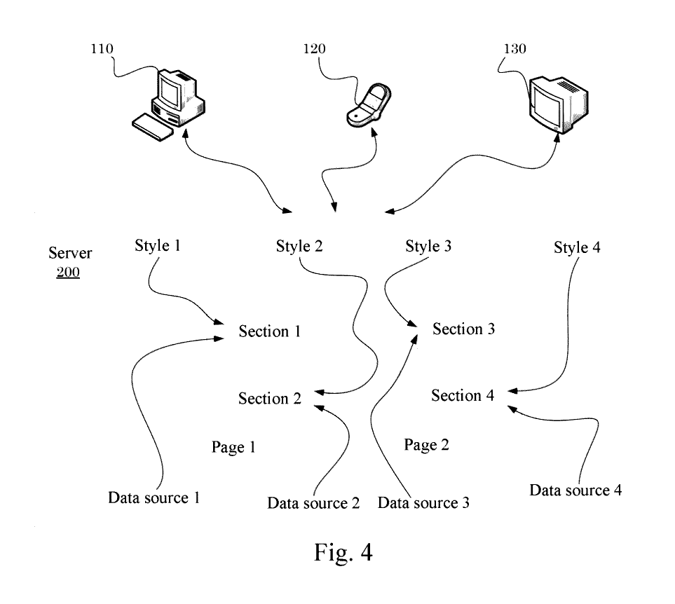

FIG. 4 is a schematic diagram of a manner for releasing content to multiple terminals according to an embodiment of the present disclosure. The manner for releasing content to multiple terminals provided in this embodiment will be described below with reference to FIG. 3.

In the figure, a page 1 includes a section 1 and a section 2, and a page 2 includes a section 3 and a section 4, where the section 1 may be defined by a data source 1 and a style 1; the section 2 may be defined by a data source 2 and a style 2; the section 3 may be defined by a data source 3 and a style 3; and the section 4 may be defined by a data source 4 and a style 4. A data source may be reused in multiple sections, and a section may be reused in multiple pages. After receiving a page request from a client, the server 200 may rapidly determine, according to the requested page in the page request and the type of the client, which sections to be included in the page and a data source and a display style of each section, and then encapsulate them and send to a corresponding client for display. In a process of maintaining a page, a working personnel only needs to adjust one data source, all sections related to the data source will be adjusted, and maintenance workload is significantly reduced. In addition, the configuration mode of flexible data source+display style can avoid a need to release a new version when in need of page adjustment caused by the page layout hardcoded in a releasing module of various terminals.

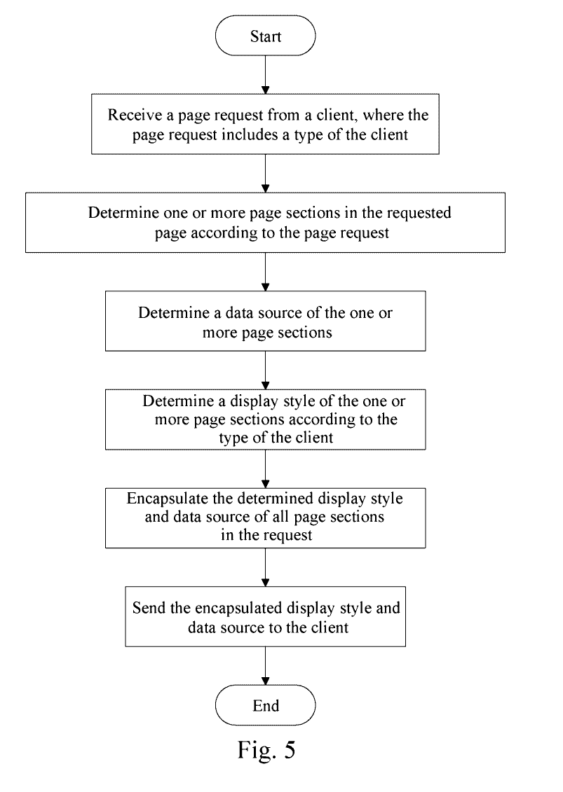

FIG. 5 is a flowchart of a method for releasing content to multiple terminals according to an embodiment of the present disclosure. Correspondingly, this embodiment further provides a method for releasing content to multiple terminals, where the method includes: receiving a page request from a client, where the page request includes the type of the client; determining one or more page sections in the requested page according to the page request; determining a data source of the one or more page sections; determining a display style of the one or more page sections (for example, a shape, a width, a height, and an image display effect of the page section) according to the type of the client; and encapsulating the determined display style and data source of all page sections in the request (for example, feasibly encapsulating in a JSON format, so that in any case various types of terminals, inter alia, a mobile phone, a computer and a television, may parse the JSON format file, to extract the display style and the data source therefrom, and thus to render and display a page according to the display style and the data source), and sending the encapsulated display style and data source to the client. By means of the method, each section is determined by data and the display style of the section, and the section may be reused in a page sent to different clients, so that a working personnel only needs to adjust one data source to be able to implement adjustment of data in the page sent to different terminals, and no longer needs to separately adjust a data source in a releasing module of each terminal.

The page request may further include information about a screen size and/or an operating system of the client; the determining a display style of the one or more page sections according to the type of the client includes determining the display style of the one or more page sections according to the type of the client and the information about the screen size and/or the operating system of the client. For example, for a television, due to its generally larger display screen, a section in a page sent thereto may use one of larger width and height, to ensure a display effect; and for a mobile phone, due to its smaller screen size, a section in a page sent thereto may use one of smaller width and height, to make it convenient for a user to operate.

By means of the foregoing technical solutions, a page is divided into sections, with page data in a structured form and a display style of the coordinated sections, and the page is output to various terminals, so that an operation and maintenance personnel only needs to maintain content in a section, and the section may be reused in multiple pages sent to multiple terminals, so as to significantly reduce maintenance workload.

Embodiment 6 of the disclosure provides a non-volatile computer storage medium, which stores computer executable instructions, where the computer executable instructions can execute the method for releasing content to multiple terminals of any of the foregoing method embodiments of the disclosure.

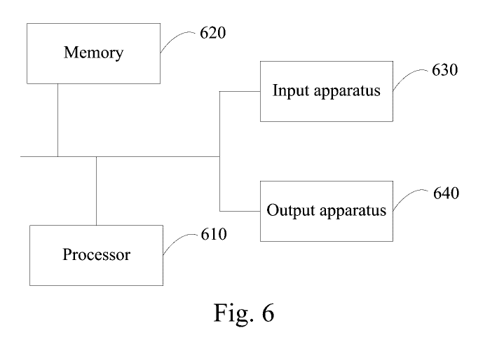

FIG. 6 is a schematic structural diagram of hardware of an electronic device for executing a method for releasing content to multiple terminals provided by Embodiment 7 of the present disclosure. As shown in FIG. 6, the device includes:

One or more processors 610 and a memory 620, with one processor 610 as an example in FIG. 6.

A device for executing the method for releasing content to multiple terminals may further include: an input apparatus 630 and an output apparatus 640.

The processor 610, the memory 620, the input apparatus 630, and the output apparatus 640 can be connected by means of a bus or in other manners, with a connection by means of a bus as an example in FIG. 6.

As a non-volatile computer readable storage medium, the memory 620 can be used to store non-volatile software programs, non-volatile computer executable programs and modules, for example, program instructions/module corresponding to the method for releasing content to multiple terminals in the embodiments of the disclosure. The processor 610 executes various functional disclosures and data processing of the server, that is, implements the method for releasing content to multiple terminals of the foregoing method embodiments, by running the non-volatile software programs, instructions, and modules stored in the memory 620.

The memory 620 may include a program storage area and a data storage area, where the program storage area may store an operating system and at least one disclosure needed by function; the data storage area may store data created by use of the apparatus for releasing content to multiple terminals, and the like. In addition, the memory 620 may include a high-speed random access memory, and also may include a non-volatile memory, such as at least one disk storage device, flash storage device, or other non-volatile solid-state storage devices. In some embodiments, the memory 620 optionally includes memories remotely disposed with respect to the processor 610, and the remote memories may be connected, via a network, to the apparatus for releasing content to multiple terminals. Examples of the foregoing network include but are not limited to: the Internet, an intranet, a local area network, a mobile communications network, and a combination thereof.

The input apparatus 630 can receive entered digit or character information, and generate key signal inputs relevant to user setting and functional control of the apparatus for releasing content to multiple terminals. The output apparatus 640 may include a display device, for example, a display screen, etc.

The one or more modules are stored in the memory 620, and execute the method for releasing content to multiple terminals in any one of the foregoing method embodiments when being executed by the one or more processors 610.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a server, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1.-5. (canceled)

6. A method for releasing content to multiple terminals, comprising:
receiving a page request from a client, wherein the page request comprises a type of the client;
determining one or more page sections in the requested page according to the page request;
determining a data source of the one or more page sections;
determining a display style of the one or more page sections according to the type of the client; and
encapsulating the determined display style and data source of all page sections in the request, and sending the encapsulated display style and data source to the client.

7. The method according to claim 6, wherein the encapsulating the determined display style and data source of all page sections in the request comprises:encapsulating the determined display style and data source of all page sections in the request in a JSON format.

8. The method according to claim 6, wherein
the page request further comprises information about a screen size and/or an operating system of the client; and
the determining a display style of the one or more page sections according to the type of the client comprises: determining the display style of the one or more page sections according to the type of the client and the information about the screen size and/or the operating system of the client.

9. The method according to claim 6, wherein the display style comprises one or more of the following:a shape, a width, a height, and an image display effect of the section.

10. The method according to claim 7, wherein the display style comprises one or more of the following:a shape, a width, a height, and an image display effect of the section.

11. The method according to claim 8, wherein the display style comprises one or more of the following:a shape, a width, a height, and an image display effect of the section.

12. A non-volatile computer storage medium, which stores a computer executable instructions, wherein the computer executable instructions are configured to:
receive a page request from a client, wherein the page request comprises a type of the client; and
determine one or more page sections in the requested page according to the page request;
determine a data source of the one or more page sections;
determine a display style of the one or more page sections according to the type of the client; and
encapsulate the determined display style and data source of all page sections in the request, and send the encapsulated display style and data source to the client.

13. The non-volatile computer storage medium according to claim 12, wherein the encapsulating the determined display style and data source of all page sections in the request comprises: encapsulating the determined display style and data source of all page sections in the request in a JSON format.

14. The non-volatile computer storage medium according to claim 12, wherein
the page request further comprises information about a screen size and/or an operating system of the client; and
the processing apparatus is further configured to determine the display style of the one or more page sections according to the information about the screen size and/or the operating system of the client.

15. The non-volatile computer storage medium according to claim 13, wherein
the page request further comprises information about a screen size and/or an operating system of the client; and
the processing apparatus is further configured for determining the display style of the one or more page sections according to the information about the screen size and/or the operating system of the client.

16. The non-volatile computer storage medium according to claim 12, wherein the display style comprises one or more of the following: a shape, a width, a height, and an image display effect of the section.

17. The non-volatile computer storage medium according to claim 13, wherein the display style comprises one or more of the following: a shape, a width, a height, and an image display effect of the section.

18. The non-volatile computer storage medium according to claim 14, wherein the display style comprises one or more of the following: a shape, a width, a height, and an image display effect of the section.

19. An electronic device, comprising:
at least one processor; and
a memory in communication connection with the at least one processor; wherein
the memory stores instructions that can be executed by the at least one processor, wherein the instructions is executed by the at least one processor, cause the at least one processor is configured to:
receive a page request from a client, wherein the page request comprises a type of the client; and
determine one or more page sections in the requested page according to the page request;
determine a data source of the one or more page sections;
determine a display style of the one or more page sections according to the type of the client; and
encapsulate the determined display style and data source of all page sections in the request, and send the encapsulated display style and data source to the client.

20. The electronic device according to claim 19, wherein the encapsulating the determined display style and data source of all page sections in the request comprises:encapsulating the determined display style and data source of all page sections in the request in a JSON format.

21. The electronic device according to claim 19, wherein
the page request further comprises information about a screen size and/or an operating system of the client; and
the processing apparatus is further configured to determine the display style of the one or more page sections according to the information about the screen size and/or the operating system of the client.

22. The electronic device according to claim 19, wherein
the display style comprises one or more of the following: a shape, a width, a height, and an image display effect of the section.

23. The method according to claim 7, wherein the page request further comprises information about a screen size and/or an operating system of the client; and
the determining a display style of the one or more page sections according to the type of the client comprises: determining the display style of the one or more page sections according to the type of the client and the information about the screen size and/or the operating system of the client.
